(19) United States
(12) Patent Application Publication
(10) Pub. No.: US 2008/0288108 A1
(43) Pub. Date: Nov. 20, 2008

(54) PROJECTION OBJECTIVE WITH DECENTRALIZED CONTROL

(75) Inventor: Torsten Gross, Zwoenitz (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/141,989

(22) Filed: Jun. 19, 2008

Related U.S. Application Data
(63) Continuation of application No. PCT/EP2006/011370, filed on Nov. 28, 2006.

(30) Foreign Application Priority Data
Dec. 22, 2005 (DE) 10 2005 062 081.7

(51) Int. Cl. B25J 9/00

(52) U.S. Cl. 700/254; 901/2; 901/47

(57) ABSTRACT

The invention relates to an objective, such as a projection objective for semiconductor microlithography. The objective can include an optical element that is adjustable by a manipulator unit with an actuator and a sensor. The manipulator unit can be driven by a control system via a data bus. The manipulator unit can have a decentralized control subsystem arranged in the region of the manipulator unit. The control subsystem can be connected to the control system via the data bus.

### CROSS-REFERENCE TO RELATED APPLICATIONS

The present application is a continuation of International Application PCT/EP2006/011370, filed Nov. 28, 2006, which claims benefit of German Application No. 10 2005 062 081.7, filed Dec. 22, 2005. The contents of international application PCT/EP2006/011370 are hereby incorporated by reference.

### FIELD

The disclosure relates to an objective, such as a projection objective for semiconductor microlithography, which has one or more optical elements that are adjustable by manipulator units that include actuators and sensors. The manipulator units can be driven by a control system via a data bus.

### BACKGROUND

Objectives, such as projection objectives for microlithography, generally include manipulators having actuators and sensors. The manipulators can be used to reduce imaging aberrations. The actuators and sensors of the manipulators are typically driven and evaluated by a central control unit. As a result, transmission paths within the objectives are generally very long. Thus, signal preamplifiers and signal amplifiers are typically used in such objectives.

### SUMMARY OF THE DISCLOSURE

The disclosure relates to a projection objective, such as a projection objective for microlithography. In some embodiments, the projection objective reduces dynamic interference sources issuing from cables and simplifies integration into a projection exposure apparatus from electrical and regulation engineering standpoints. In certain embodiments, reduction of dynamic interference and simplified integration can be achieved even when the projection objective includes a large number of active manipulator units.

In some embodiments, the projection includes manipulator units that have multiple dedicated, decentralized control subsystems. The decentralized control subsystems can be arranged in the region of the manipulator units and can be connected to the control system via a common data bus formed in digital fashion. The control subsystems can be designed to independently execute communicated control commands of the control system by regulating actuators of the manipulator units with the aid of sensors.

In certain embodiments, each manipulator unit is provided with an independent control subsystem/controller. As a result, the cabling outlay can advantageously be reduced to one bus line and to one power supply line. Since signal amplifiers are positioned very close to the sensors and actuators, interference over long cable sections can be avoided. The signal conditioning and signal processing can be effected directly in the control subsystem of the manipulator. The communication between the manipulator unit and control system or objective controller is generally limited to manipulator control commands of the control system and to status feedback messages of the manipulator unit to the control system. Since this communication is effected digitally, communication errors can be detected by error correction measures (e.g. CRC check sums or the like) and thus avoided.

The control subsystems described herein, which, on account of their regulation functionality, could also be referred to as regulation subsystems, are suitable for various types of projection objectives. The control subsystems can, for example, be adapted to any of various actuators and sensors by software modification. Consequently, the projection objective can also be extended by new active manipulators. Moreover, signal amplification may be obviated in part. Signal transmission losses can be significantly reduced.

In some embodiments, the control subsystems have at least one microprocessor and at least one data memory. Calibration data for the respective actuators and sensors of the associated manipulator units can be stored in the data memory of the control subsystems.

The control subsystem can autonomously supervise the functions of the associated manipulator unit. This includes the driving of the manipulators/actuators as well as the evaluation of the corresponding sensors. In some embodiments, the calibration data of the actuators and sensors and also the characteristic curve of the entire manipulator mount are stored in the data memory of the control subsystems. As a result, the microprocessor is enabled to compensate for or take account of drift processes during the regulation and also to monitor the thermal behaviour of the entire manipulator unit. The integration of a control subsystem into the manipulator unit leads to an additional input of energy. This additional input of energy can be compensated for in a variety of ways. In certain embodiments, for example, peltier elements or heating foils are fitted on the manipulator and keep the manipulator at a specific temperature level using a regulating circuit. The use of active and passive cooling systems is likewise possible for the temperature regulation. Furthermore, the actuators can be driven by pulse width modulation (PWM). The main component of the control subsystem is the microprocessor. The control subsystem may also have a temperature control. Multiplexers and A/D converters, and demultiplexers and D/A converters are generally provided for connection and driving of the sensors and actuators. An interface controller can regulate access to the data bus.

In some embodiments, the control subsystems of the manipulator units are arranged on a housing of the projection objective (e.g., on an outer side of the housing of the projection objective). This arrangement can reduce (e.g., eliminate) the introduction of additional heat into the projection objective.

In certain embodiments, a separate power supply unit is provided for controlling the power supply of the control subsystems and of the manipulator units.

The power supply unit undertakes the power management of the manipulator units, which is effected independently of the control unit of the projection objective. Power supply and signal communication are thereby separate. The control subsystem can communicate directly with the power supply unit, whereby the power demand can be coordinated precisely with the functions of the manipulator. Thermal supervision of the manipulator unit by the control subsystem is also possible.

An exemplary embodiment is described in principle below with reference to the drawings.

### BRIEF DESCRIPTION OF THE DRAWINGS

FIG. 1 shows a basic illustration of a projection exposure apparatus for microlithography, which can be used for the exposure of structures onto wafers coated with photosensitive materials, in accordance with the prior art;

FIG. 2 shows an illustration of a regulating circuit for a manipulator unit in accordance with the prior art;

FIG. 3 shows an illustration of a regulating circuit of a projection objective in accordance with the prior art;

FIG. 4 shows an illustration of a projection objective with manipulator control subsystems;

FIG. 5 shows an illustration of a manipulator unit with a control subsystem; and

FIG. 6 shows an illustration of a fundamental construction of a control subsystem of a manipulator unit.

### DETAILED DESCRIPTION

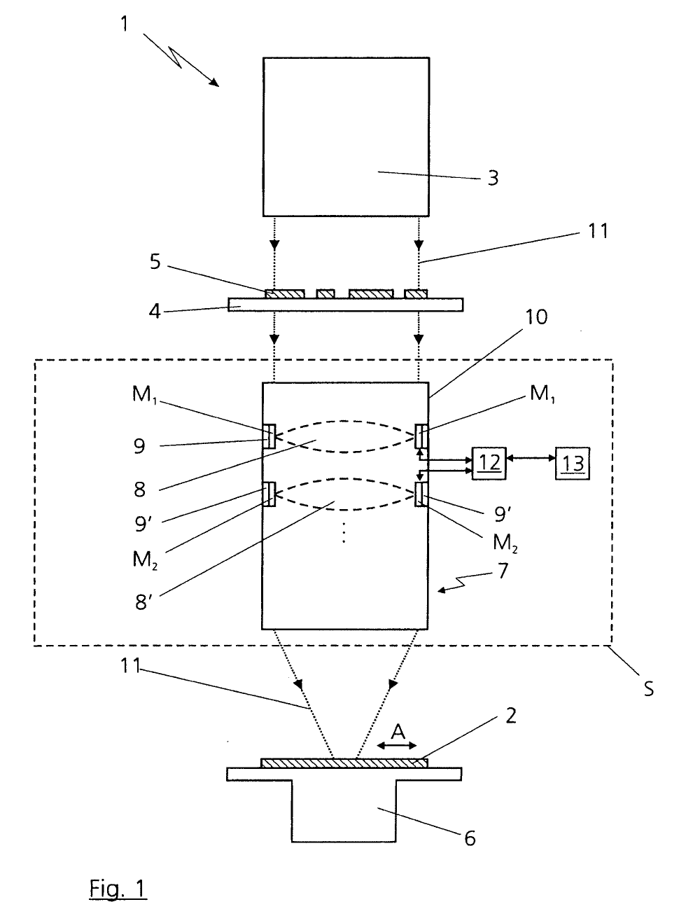

FIG. 1 illustrates a projection exposure apparatus 1 for microlithography. The apparatus can be used for the exposure of structures onto a substrate coated with photosensitive materials, which generally predominantly includes silicon and is referred to as a wafer 2, for the production of semiconductor components, such as computer chips.

The projection exposure apparatus 1 includes an illumination device 3, a device 4 for receiving and precisely positioning a mask provided with a grating-like structure, a so-called reticle 5, which determines the later structures on the wafer 2, a device 6 for the mounting, movement and precise positioning of the wafer 2, and an imaging device, namely a projection objective 7 with multiple optical elements (e.g. lenses) 8, 8′, which are mounted via mounts 9, 9′ and/or manipulator units M₁, M₂ in an objective housing 10 of the projection objective 7.

The projection exposure apparatus allows for structures introduced into the reticle 5 to be imaged onto the wafer 2 in demagnified fashion.

After an exposure has been effected, the wafer 2 is moved further in the arrow direction A (or xy direction), so that multiple individual fields, each having the structure predetermined by the reticle 5, are exposed on the same wafer 2.

The illumination device 3 provides a projection beam 11, such as light or a similar electromagnetic radiation, that provides for the imaging of the reticle 5 on the wafer 2. A laser or the like may be used as a source for the radiation.

The manipulators M₁, M₂ are driven and evaluated by a central control system 12 of the projection objective 7, the so-called lens controller, which is in turn controlled by a superordinate control system 13 of the projection exposure apparatus.

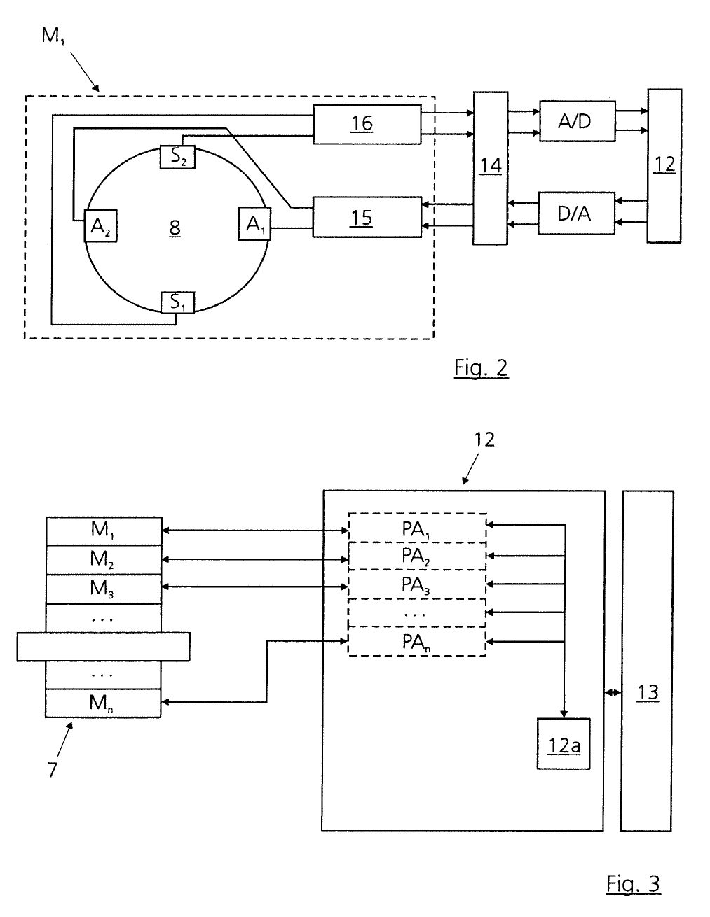

The signal transmission paths are generally very long. As a result, as shown in FIGS. 2 and 3, the control system 12 of the projection objective 7 uses not only analogue/digital converters A/D and digital/analogue converters D/A but additionally signal amplifiers 14 and signal preamplifiers PA₁, . . . , PAₙ for driving the actuators A₁, A₂ (e.g. piezo-actuators, Lorenz actuators or the like) via an actuator interface 15 or for evaluating sensors S₁, S₂ via a preamplifier 16. The driving of the manipulator unit M₁ of the lens 8 by the central control system 12 of the projection objective 7 in accordance with the prior art is illustrated in principle in FIG. 2.

FIG. 3 illustrates in a simplified manner the regulation of manipulator units M₁, . . . , Mₙ by the central control system 12 of the projection objective 7 via preamplifiers PA₁, . . . , PAₙ by a controller 12a in accordance with the prior art, corresponding to the detail S in FIG. 1. The use of the amplifiers and the preamplifiers 14, 16, PA₁, . . . , PAₙ can corrupt the sensor signals, which can affect the measurement accuracy during the evaluation of the sensor signals by the control system 12 of the projection objective 7. Applicable causes include, for example, non-linearity of the amplifier characteristic curves and temperature drifts. In the case of capacitive sensors, the sensor cable is generally tuned to the sensor and the preamplifier used; if this tuning is inadequate, signal reflections may occur, which can have adverse effects on the measurement signals. Crosstalk may likewise couple interference signals into the signal cables.

The use of the preamplifiers PA₁, . . . , PAₙ and the long transmission paths can result in an increase in the power loss and thus the heat in the projection objective 7 or in the projection exposure apparatus 1. Thus, a complicated heat dissipation technique is generally used with such objectives.

In the case of previous projection objectives 7, the control system 12 of the projection objective 7 directly undertakes the regulation of the manipulator units M₁, . . . , Mₙ. In the case of the projection objectives of this disclosure, the control system 12 includes the signal conditioning, the signal processing and also the actual controller 12a (see FIG. 3).

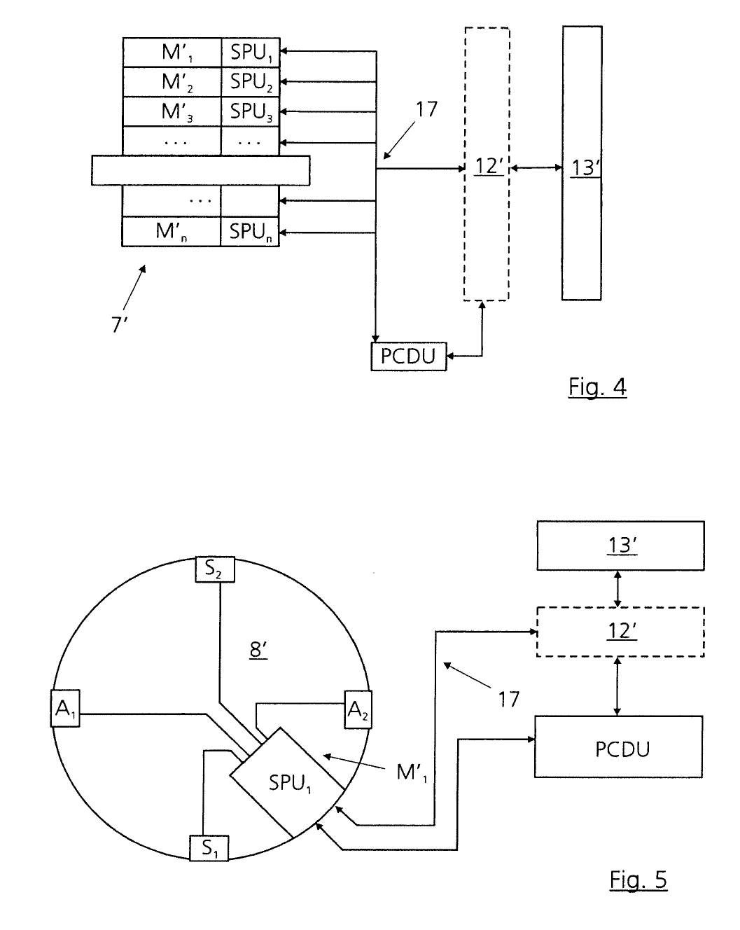

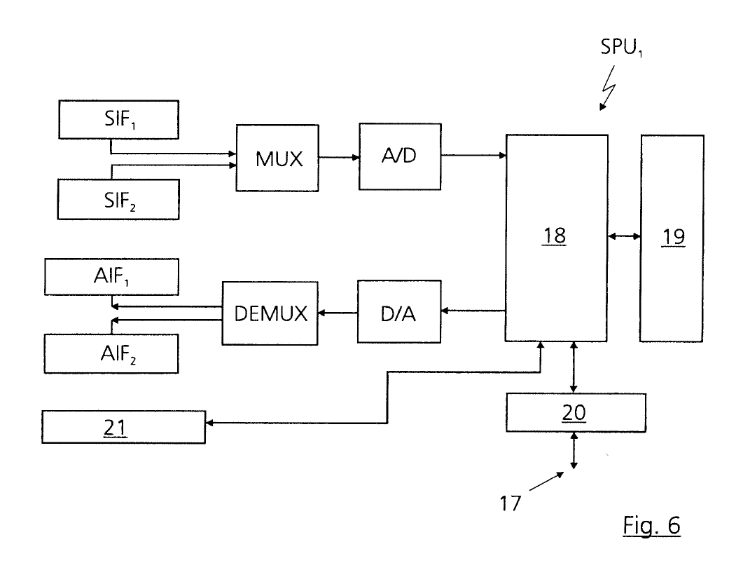

As can be seen from FIG. 4, manipulator units M′₁, . . . , M′ₙ f a projection objective 7′ according to the disclosure for use in the projection exposure apparatus 1 have dedicated, decentralized control subsystems SPU₁, . . . , SPUₙ which are arranged in the region of the manipulator units M′₁, . . . , M′ₙ and which are connected to a control system 12′ via a common data bus 17 formed in digital fashion. FIG. 4 shows the detail S from FIG. 1 in a simplified manner in the embodiment according to the disclosure. The control subsystems SPU₁, . . . , SPUₙ convert the control commands communicated by the control system 12′ independently via a regulation of the actuators A₁, A₂ and with the aid of the sensors S₁, S₂ (see FIGS. 5 and 6). The signal conditioning and signal processing are effected directly in the manipulator control subsystems SPU₁, . . . , SPUₙ. In the case of the projection objective 7′, a respective microprocessor is integrated directly in the manipulator units M′₁, . . . , M′ₙ as a manipulator control subsystem. The communication between manipulator unit M′₁, . . . , M′ₙ and control system 12′ is thus limited to the manipulator unit M′₁, . . . , M′ₙ receiving from the control system 12′ control commands for manipulation of the corresponding optical element or the optical assembly (e.g., lenses 8, 8′—not specifically illustrated in FIG. 4) and then reporting its status back to the control system 12′. Since this communication is effected digitally, communication errors can be reliably detected and thus precluded using suitable error correction measures.

As can furthermore be seen from FIG. 4, a power supply unit PCDU undertakes the power management of the manipulator units M′₁, . . . , M′ₙ. This is effected independently of the control unit 12′ of the projection objective 7′ and constitutes an EMC separation between power supply and signal transmission.

As can be seen from FIG. 5, the manipulator M′₁ has an autonomous control subsystem SPU₁. The signal processing of the sensors S₁, S₂ is effected directly in the control subsystem SPU₁ of the manipulator unit M′₁. The actuators A₁, A₂ are likewise driven and regulated by the control subsystem SPU₁. In some embodiments, the control subsystem SPU₁ is formed as an autonomous controller. In further embodiments, the latter could also be dependent on the control system 12′. The control subsystem SPU₁ communicates with the control system 12′ and the power supply unit PCDU via a standardized interface. The communication between the control subsystem SPU₁ and the power supply unit PCDU takes place independently of the control system 12′. The control system 12′ prescribes for the control subsystem SPU₁ a command sequence for manipulation of the optical element or the lens 8′, which the control subsystem SPU₁ then processes independently and subsequently reports the status back to the control system 12′. The control subsystem SPU₁ can communicate directly with the power supply unit PCDU, as a result of which the power demand can be coordinated precisely with the functions of the manipulator M′₁. In certain embodiments, the control subsystem SPU₁ also undertakes the thermal supervision of the manipulator M′₁.

FIG. 6 shows the basic construction of the control subsystem SPU₁ of the manipulator unit M′₁. The main component of the control subsystem SPU₁ is a microprocessor 18. The control subsystem SPU₁ also has a data memory 19. The control subsystem SPU₁ is constructed in a manner similar to a PCMCIA card, an SD card or the like. The card can be readily accessible in order to ensure an exchange in the case of an upgrade or service. The card could then be inserted into a drawer compartment or the like in the mount. The control system SPU₁ autonomously supervises the functions of the manipulator unit M′₁. This includes the driving, i.e., the regulation of the actuators A₁, A₂, as well as the evaluation of the sensor signals of the sensors S₁, S₂. The actuators A₁, A₂ are driven via a digital/analogue converter D/A and a demultiplexer DEMUX via actuator interfaces AIF₁, AIF₂. The sensor signals of the sensors S₁, S₂ are received from sensor interfaces SIF₁, SIF₂ via a multiplexer MUX and an analogue/digital converter A/D. The calibration data of the actuators A₁, A₂ and of the sensors S₁, S₂ and also the characteristic curve of the entire mount can advantageously be stored in the data memory 19 of the control subsystem SPU₁. This enables the microprocessor 18 to compensate for and immediately take account of drift processes during the regulation. A further function of the control subsystem SPU₁ is the monitoring of the thermal behaviour of the entire manipulator M′₁.

The integration of the control subsystem SPU₁ in the manipulator M′₁ may lead to an additional input of energy. However, this can be compensated for by various different countermeasures. The temperature of the manipulator M′₁ can, for example, be regulated using Peltier elements. There is also the possibility of fitting heating foils on the manipulator M′₁, which keep the manipulator M′₁ at a specific temperature level using a regulating circuit. The use of active and passive cooling systems is likewise possible for the temperature regulation.

In addition, the control subsystem SPU₁ has an interface controller 20 and, for thermal regulation, a thermal controller 21.

The data interface of the control subsystem SPU₁ has an electrical physical interface and a software interface. Both interfaces are dependent on the data transmission protocol to be chosen. Serial as well as parallel data transmission are conceivable. Bus systems (e.g. MIL1553, LAN, CAN) are appropriate for serial data transmission. It is also possible to realize potential isolation of the data interfaces with respect to the other bus subscribers (MIL1553). The management of the data interface is carried out by the interface controller 20.

The manipulator units M′₁, . . . , M′ₙ are integrated into the control of the projection exposure apparatus 1 via the control system 12′ of the projection objective 7′, which is controlled by the control system 13′ of the projection exposure apparatus 1. The control system 12′ of the projection objective 7′ may also be omitted (indicated by dashed lines in FIGS. 4 and 5). The task of the control system 12′ of the projection objective is to coordinate the control subsystems SPU₁, . . . , SPUₙ, which could also be undertaken by the control system 13′. Furthermore, the characteristic curve of the projection objective 7′ may be stored in the control system 12′. The communication between the control system 12′ of the projection objective 7′ and the control system 13′ of the projection exposure apparatus 1 includes exchanging control commands and status messages. The projection objective 7′ thus forms an autonomous subsystem of the projection exposure apparatus 1. As a result of storing the projection objective characteristic curve, thermal and drift effects can also be compensated for during the regulation. The same can be achieved with regard to the manipulator units by storing the manipulator characteristic curve in the corresponding control subsystems.

Overall, an advantageous overall system is created by the decentralized arrangement of the control subsystems SPU₁, . . . , SPUₙ. Signal transmission losses are reduced (e.g., minimized). Signal amplification can for the most part be omitted. The interfaces to the control device 13′ of the projection exposure apparatus 1 are reduced. By compensating for drift effects, it is possible to achieve a lengthening of the service life of the projection objective 7′. The manipulator characteristic curves can be included fully automatically for each mount in the respective control subsystem SPU₁, . . . , SPUₙ. The control subsystems SPU₁, . . . , SPUₙ can be used for various different types of projection objectives. The control subsystems SPU₁, . . . , SPUₙ can be adapted to any actuator A₁, A₂ and sensor S₁, S₂ by modifications of the computer software that is executed. As a result, mechanical tolerances can be chosen to be coarser in a simple and advantageous manner. When a serial data bus 17 is used, only a single cable is used for the data exchange between all the manipulator units M′₁, . . . , M′ₙ and the control system 12′. For redundancy reasons, the control subsystems SPU₁, . . . , SPUₙ can therefore have at least two data interfaces to the data bus 17. New functions can be implemented at any time by software changes. The thermal supervision is now possible directly at the manipulator. Power supply line and signal line are separate. Overall, the structural space requirement in the projection exposure apparatus 1 is reduced.

What is claimed is:

1. An objective, comprising:
an optical element;
a manipulator unit connected to the optical element, the manipulator unit comprising:
an actuator;
a sensor; and
a decentralized control system; and
a control system capable of being connected to the manipulator unit,
wherein the decentralized control subsystem of the manipulator unit is capable of being connected to the control system via a data bus, the actuator and sensor of the manipulator unit are adapted to adjust the optical element, and the objective is configured to be used in semiconductor microlithography.

2. The objective of claim 1, wherein the decentralized control subsystem is adapted to control the actuator.

3. The objective of claim 1, wherein the decentralized control subsystem is adapted to receive and process signals from the sensor.

4. The objective of claim 1, wherein the decentralized control subsystem is adapted to control the actuator based on data received from the control system.

5. The objective of claim 1, wherein the decentralized control subsystem has at least one microprocessor and memory.

6. The objective of claim 5, wherein the memory of the decentralized control subsystem is capable of storing calibration data for the actuator and sensor of the manipulator unit.

7. The objective of claim 1, wherein the objective further comprises a housing in which the optical element is disposed, and the decentralized control subsystem of the manipulator unit is attached to the housing.

8. The objective of claim 7, wherein the decentralized control subsystem of the manipulator unit is attached to an outer surface of the housing.

9. The objective of claim 1, further comprising a power supply unit connected to the decentralized control subsystem.

10. The objective of claim 9, wherein the power supply unit is adapted to supply power to the decentralized control subsystem based on data received from the decentralized control subsystem.

11. The objective of claim 1, wherein the objective comprises a plurality of optical elements, each of the optical elements being connected to an associated manipulator unit.

12. The objective of claim 1, further comprising a cooling device adapted to control the temperature of the manipulator unit.

13. The objective of claim 12, wherein the cooling device comprises a peltier element, the peltier element being thermally coupled to the manipulator unit.

14. The objective of claim 12, wherein the cooling device comprises a heating foil, the heating foil being thermally coupled to the manipulator unit.

15. The objective of claim 1, wherein the decentralized control subsystem is adapted to drive the actuator by pulse width modulation.

16. An apparatus, comprising:
an illumination device; and
the objective of claim 1,
wherein the apparatus is a projection exposure apparatus configured to be used in semiconductor microlithography.

17. A method comprising using a projection exposure apparatus to make semiconductor components, wherein the projection exposure apparatus comprises:
an illumination device; and
the objective of claim 1.

18. An objective, comprising:
a housing;
an optical element disposed in the housing; and
a manipulator unit connected to the optical element, the manipulator unit comprising a control subsystem that is attached to the housing,
wherein the objective is configured to be used in semiconductor microlithography.

19. The objective of claim 18, wherein the control subsystem of the manipulator unit is attached to an outer side of the housing.

20. The objective of claim 18, wherein the control subsystem is adapted to control the manipulator unit.

21. The objective of claim 18, further comprising a control system capable of being connected to the control subsystem via a data bus.

22. The objective of claim 21, wherein the control subsystem is adapted to control the manipulator unit based on data received from the control system.

23. The objective of claim 18, further comprising a cooling device adapted to control the temperature of the manipulator unit.

24. The objective of claim 18, wherein the decentralized control subsystem is adapted to drive the actuator by pulse width modulation.
